(19) United States
(12) Patent Application Publication
(10) Pub. No.: US 2026/0322426 A1
(43) Pub. Date: Oct. 15, 2026

(54) METHODS, APPARATUSES AND SYSTEMS FOR DEEP LEARNING MIMO CHANNEL ESTIMATION FOR INTELLIGENT REFLECTION SURFACE INSTALLED USER EQUIPMENT

(71) Applicant: Kyocera Corporation, Kyoto (JP)

(72) Inventor: Amit KALHAN, San Diego, CA (US)

(21) Appl. No.: 19/483,767

(22) PCT Filed: Jun. 13, 2024
(86) PCT No.: PCT/US2024/033860

§ 371 Date: Nov. 12, 2025

Related U.S. Application Data
(60) Provisional application No. 63/522,041, filed on Jun. 20, 2023.

(51) Int. Cl. H04B 7/04; H04L 25/02

(52) U.S. Cl. CPC H04B 7/04013; H04L 25/0224

(57) ABSTRACT

Methods, apparatuses and systems for deep learning multiple-input and multiple-output (MIMO) channel estimation for intelligent reflecting surface (IRS) installed user equipment (UE), wherein a wireless communication device includes: a transceiver configured to receive a first signal at a first frequency from a wireless communication node; and an IRS configured to reflect the first signal to generate a reflected first signal back to the wireless communication node, wherein the reflected first signal is used for a channel estimation at a second frequency, wherein the first frequency and the second frequency are different, wherein the channel estimation is performed by estimating channel measurements on an uplink channel at the second frequency, wherein the channel measurements on the uplink channel at the second frequency are estimated using a neural network (NN) model.

### TECHNICAL FIELD

The disclosure relates generally to wireless communications and, more particularly, to methods, apparatuses and systems for deep learning multiple-input and multiple-output (MIMO) channel estimation for intelligent reflecting surface (IRS) installed user equipment (UE).

### BACKGROUND

An IRS is a planar surface comprising a plurality of small, reconfigurable reflecting elements, each of which can induce a controllable amplitude, phase and/or polarization change to the incident signal independently, without need of baseband processing. IRSs are designed to reflect, refract, or scatter incoming electromagnetic waves in a way that optimizes signal strength, minimizes interference, and enhances overall wireless communication performance.

On the other hand, in a wireless communication system, signals are transmitted through wireless channels established between transmitters and receivers. These channels introduce various impairments and distortions to the transmitted signals due to factors such as fading, interference, and noise. Channel estimation in wireless communication is a process used to estimate the characteristics of the communication channel through which signals are transmitted. To perform channel estimation, a base station (BS) can transmit a reference signal (RS) to a UE coupled to an IRS, and the IRS can be configured to reflect the RS back to the BS. Then the BS can perform channel estimation on the received reflected RS to compute a precoder for the data transmission to the same UE.

However, the IRS-aided channel estimation method can only be applied for downlink channel estimation, and it cannot be applied directly for frequency division duplex (FDD) uplink transmission. The uplink channel estimates cannot be obtained directly from the downlink frequency channel measurements because the channel varies across the uplink and downlink frequency bands. Therefore, there is a need to develop new methods and systems for improving the efficiency and accuracy of uplink channel estimation.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method includes: receiving, at a wireless communication device, a first signal at a first frequency from a wireless communication node; and reflecting, at the wireless communication device, the first signal to generate a reflected first signal back to the wireless communication node, wherein the first signal is reflected using an intelligent reflecting surface (IRS) coupled to the wireless communication device, wherein the reflected first signal is used for a channel estimation of a second frequency, and wherein the first frequency and the second frequency are different.

In some embodiments, the channel estimation of the second frequency is performed by estimating channel measurements on an uplink channel at the second frequency, wherein the channel measurements on the uplink channel at the second frequency are estimated using a neural network (NN) model, wherein the NN model is trained using a plurality of training samples, wherein each of the plurality of training samples includes: an IRS-reflected reference signal (RS) measurement at the first frequency; and an associated sounding reference signal (SRS) measurement transmitted from the wireless communication device to the wireless communication node at the second frequency.

In some embodiments, the first signal includes a plurality of orthogonal frequency-division multiplexing (OFDM) symbols, wherein each of the plurality of OFDM symbols is transmitted from the wireless communication node to a respective one of a plurality of antennas in the IRS during a respective one of a plurality of symbol durations, wherein: during the respective one of the plurality of symbol durations, the respective one of the plurality of antennas is activated while all other antennas in the plurality of antennas are deactivated.

In some embodiments, the channel measurements on the uplink channel at the second frequency are predicted using inputs of the NN, wherein the inputs of the NN are obtained by: converting the reflected first signal from a radio frequency (RF) format to a digital format; and converting the reflected first signal with the digital format from a complex number to a one-dimensional vector.

In some embodiments, the method further includes: receiving, at the wireless communication device, a plurality of second signals at the first frequency from the wireless communication node; and reflecting, at the wireless communication device, each of the plurality of second signals to generate a respective one of a plurality of reflected second signals back to the wireless communication node using the IRS coupled to the wireless communication device, wherein the reflected first signal and the plurality of reflected second signals are used to predict the channel measurements on the uplink channel at the second frequency using the NN.

In some embodiments, the reflected first signal and the plurality of reflected second signals are combined into a combined signal for predicting the channel measurements on the uplink channel at the second frequency, wherein a first signal strength of the combined signal is stronger than a second signal strength of the reflected first signal.

In some embodiments, the NN is a feedforward fully connected multi-layer perceptron (MLP).

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates an exemplary wireless communication network for wireless communication and channel estimation, in accordance with some embodiments of the present disclosure.

FIG. 3 illustrates a deep neural network system at a base station used for intelligent reflecting surface-aided base station to user equipment channel estimation, in accordance with some embodiments of the present disclosure.

FIG. 4 illustrates a deep neural network model, in accordance with some embodiments of the present disclosure.

FIG. 5 illustrates a training structure for channel estimation of uplink transmissions in frequency division duplex networks, in accordance with some embodiments of the present disclosure.

FIG. 6 illustrates an example method for performing deep learning multiple-input and multiple-output channel estimation for IRS installed user equipment, in accordance with some embodiments.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

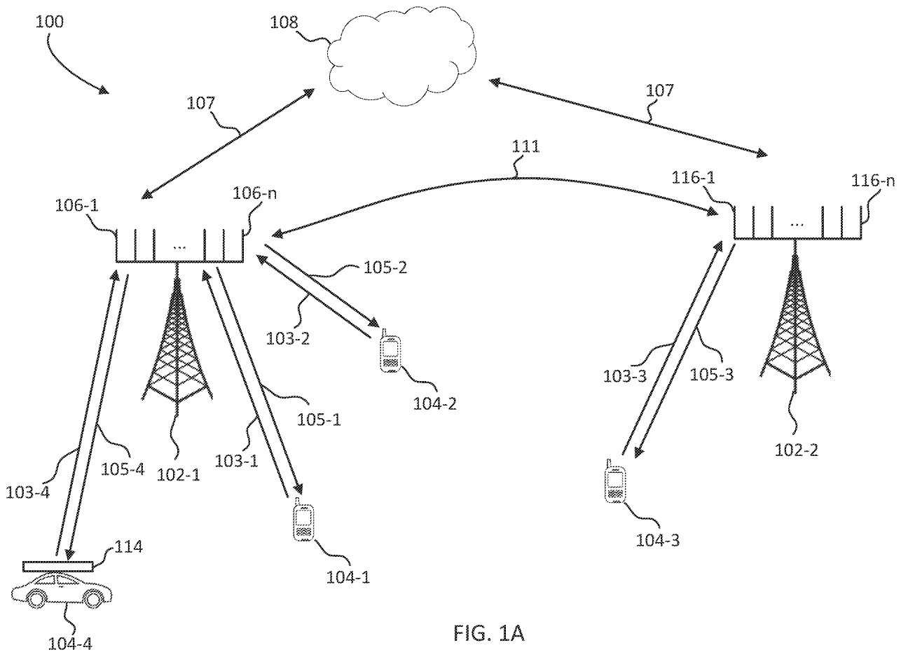

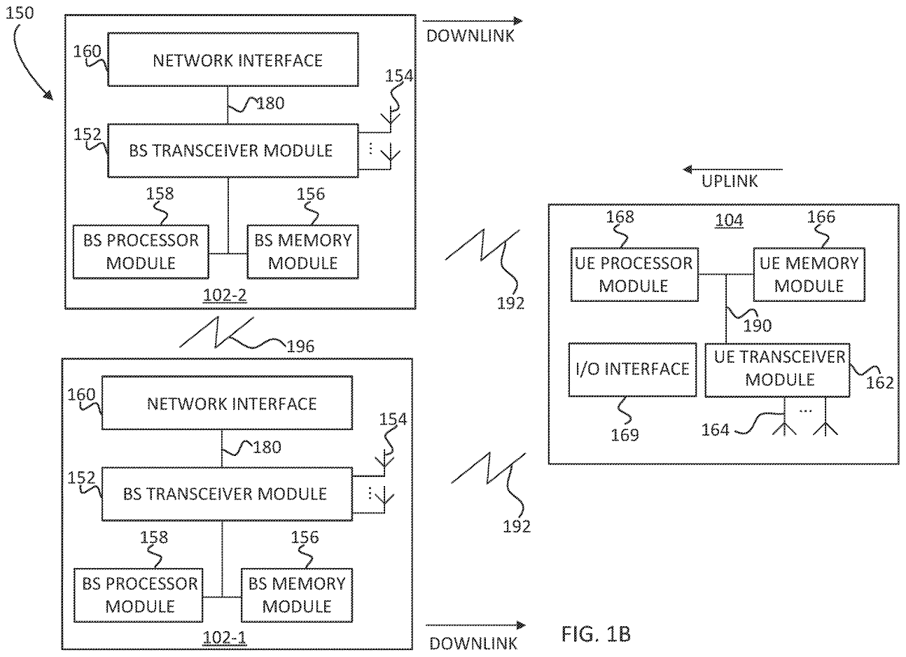

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device” herein. Such communication nodes and communication devices may be capable of wireless and/or wired communications, in accordance with various embodiments of the invention. It is noted that all the embodiments are merely preferred examples, and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a second BS 102-2, a first UE 104-1, a second UE 104-2, a third UE 104-3, and a fourth UE 104-4. In some embodiments, the first BS 102-1 and the second BS 102-2 comprise a first plurality of antennas 106-1 to 106-n and a second plurality of antennas 116-1 to 116-n, respectively. The first plurality of antennas 106-1 to 106-n may communicate with a plurality of UEs 104 to form a first multiple-input multiple-output (MIMO) system, and the second plurality of antennas 116-1 to 116-n may communicate with the plurality of UEs 104 to form a second MIMO system.

In some embodiments, a plurality of UEs 104 may form direct communication (i.e., uplink) channels 103-1, 103-2, 103-3, and 103-4 with the first BS 102-1 and the second BS 102-2. In some embodiments, the plurality of UEs 104 may also form direct communication (i.e., downlink) channels 105-1, 105-2, 105-3, and 105-4 with the first BS 102-1 and the second BS 102-2. The direct communication channels between the plurality of UEs 104 and a distributed unit of the BS 102 can be through interfaces such as an Uu interface, which is also known as E-UTRAN air interface. In some embodiments, the UE 104 comprises a plurality of transceivers which enables the UE 104 to support multi connectivity so as to receive data simultaneously from the first BS 102-1 and the second BS 102-2. The first BS 102-1 and the second BS 102-2 each is connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), User Plane Function (UPF), and System Management Function (SMF).

A direct communication channel 111 between the first BS 102-1 and the second 102-2 is through an X2 interface. In some embodiments, a BS (gNB) is split into a Distributed Unit (DU) and a Central Unit (CU) on the UP, between which the direct communication is through a F1-U interface. In some embodiments, a CU of the second BS 102-2 can be further split into a Control Plane (CP) and a User Plane (UP), between which the direct communication is through an E1 interface. Hereinafter in the present disclosure, an Xx interface is used to describe one of the following interfaces, the NG interface, the S1 interface, the X2 interface, the Xn interface, the F1 interface, and the E1 interface. When an Xx interface is established between two nodes, the two nodes can transmit control signaling on the CP and/or data on the UP.

In some embodiments, one of the plurality of UEs 104, such as the UE 104-4 may comprise an Intelligent Reflecting Surface (IRS) 114 attached to the main body of the UE 104-4. The IRS 114 may be referred to as a planar surface comprising a plurality of small, reconfigurable reflecting elements, each of which can induce a controllable amplitude, phase and/or polarization change to the incident signal independently, without any need of baseband processing. In one embodiment, the UE 104-4 is a vehicle, and the IRS 114 may be installed on the roof of the UE 104-4. In another embodiment, the IRS 114 is installed on mobile robots of the UE 104-4. In yet another embodiment, the UE 104-4 is an uncrewed aerial vehicle (UAV) and the IRS 114 is placed facing the ground. In still another embodiment, the UE 104-4 is a handheld device, and the IRS 114 is installed on the UE 104-4. In some embodiments, the UE 104-4 is connected to the IRS 114 through a wire while the UE 104-4 and the IRS 114 are located at different locations. In still another embodiment, the UE 104-4 comprises the IRS 114. In some other embodiments, the UE 104-4 and the IRS 114 are located at different locations, and the UE 104-4 is connected to the IRS 114 through a wireless communication channel using antennas installed on both the UE 104-4 and the IRS 114. In one embodiment, the IRS 114 is configured to reflect incident signals transmitted from the BS 102-1 for positioning estimation of the UE 104-4, while the UE 104-4 and the IRS 114 are located at different locations. In this embodiment, the UE 104-4 may be configured to transmit a UE message (e.g. UE capability message) to the BS 102-1, wherein the UE message comprises the location of the IRS 114 (e.g. distance and direction) relative to the UE 104-4. In this way, the BS 102-1 may determine the exact location of the IRS 114 using the location of the IRS 114 relative to the UE 104-4 and the exact location of the UE 104-4. In another embodiment, the exact location of the IRS 114 is predetermined and transmitted to the BS 102-1 through the UE message. In yet another embodiment, the exact location of the IRS 114 is predetermined and stored in the BS 102-1. In some embodiments, the BS 102-1 is configured to generate incident signals to the UE 104-4, and the UE 104-4 may be configured to reflect the incident signals towards specific directions using the installed IRS 114 for channel estimation between the BS 102-1 and the UE 104-4.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

Referring again to FIG. 1A, during the transmission of signals between the BS 102 and the UE 104, the established wireless transmission channels between the BS 102 and the UE 104 may introduce various impairments and distortions to the transmitted signals due to factors such as fading, interference, and noise. Channel estimation can be performed to estimate the characteristics of the communication channel between the BS 102 and the UE 104 to optimize wireless communication system performance and to improve the reliability of communication. A conventional way to perform channel estimation is to use channel reciprocity for MIMO precoding in the downlink by estimating the UL channel based on the symmetry properties between the UL and DL channels. That is, the UE 104 can periodically transmit pilot signals or Sounding Reference Signals (SRSs) during specific time slots allocated for UL channel sounding, and the corresponding BS 102 can measure the received SRSs to estimate the UL channel characteristics such as channel gains and phases. In case of a time-division duplexing (TDD) transmission, there is channel reciprocity between the UL and DL channels. This means that the UL and DL channel responses are related, allowing information obtained from UL measurements to be used for DL transmission. For example, the BS 102 can perform DL MIMO precoding based on the extracted UL channel state information (CSI) from the received pilot signals or SRSs. Once the DL MIMO precoding matrix is determined, the BS 102 can use it to precode the DL data transmission, which helps in mitigating the effects of channel fading and interference and improving the quality of the received signal at the UEs. However, this method suffers from the fact that SRS resources are limited and if many UEs need to be accommodated, these SRS resources need to be reused, thus creating interference, which limits the accuracy of channel estimation and hence MIMO performance. Although several schemes to mitigate this problem, such as SRS multiplexing in the time and frequency domain, SRS cyclic shift hopping or combinations of all these, the SRS interference issue remains a limiting factor for reciprocity-based MIMO in currently deployed systems.

Another conventional method for estimating the channel, applicable to both TDD and frequency division duplex (FDD), is performed by the UE 104 wherein the UE 104 uses Channel State Information Reference Signals (CSI-RS) transmitted from the BS 102 to generate a Channel State Information (CSI) report that comprises: Precoding Matrix Indicator (PMI), Rank Indicator (RI) and Channel Quality Indicator (CQI). For example, the BS 202 may be configured to periodically transmit known pilot signals to the UE 104 during specific time slots, wherein the pilot signals are known to both the BS 102 and the UE 104. The UE 104 may then use the pilot signals to estimate the channel characteristics. That is, during the reception of the pilot signals, the UE 204 may measure the received signal strength, phase, and other relevant parameters, and use these parameters to estimate the channel characteristics between the UE 104 and the BS 102.

After performing the channel estimation, the UE 104 may be configured to send feedback signals back to the BS 102, wherein each of the feedback signals may comprise a CSI report that comprises at least one of: a PMI, an RI and a CQI. The BS 102 may then use the feedback signals to adapt its transmission parameters, such as modulation, coding, and beamforming in a precoding process, to optimize communication with the UE 104. For transmission with medium and high speeds, this method has been found to suffer from the “channel aging” problem. That is, that by the time the BS 102 receives the feedback signals generated from the UE 104, the CSI report included in the feedback signals may become dated as the channel condition has changed significantly during the UE measurement and UE reporting interval. One major reason for the “channel aging” problem is that the UE 104 needs a significant amount of time to compute the CSI report, and when the CSI report is completed, the channel condition may have changed significantly. The time that the UE 104 needs to compute the CSI report is known as “CSI computation delay”.

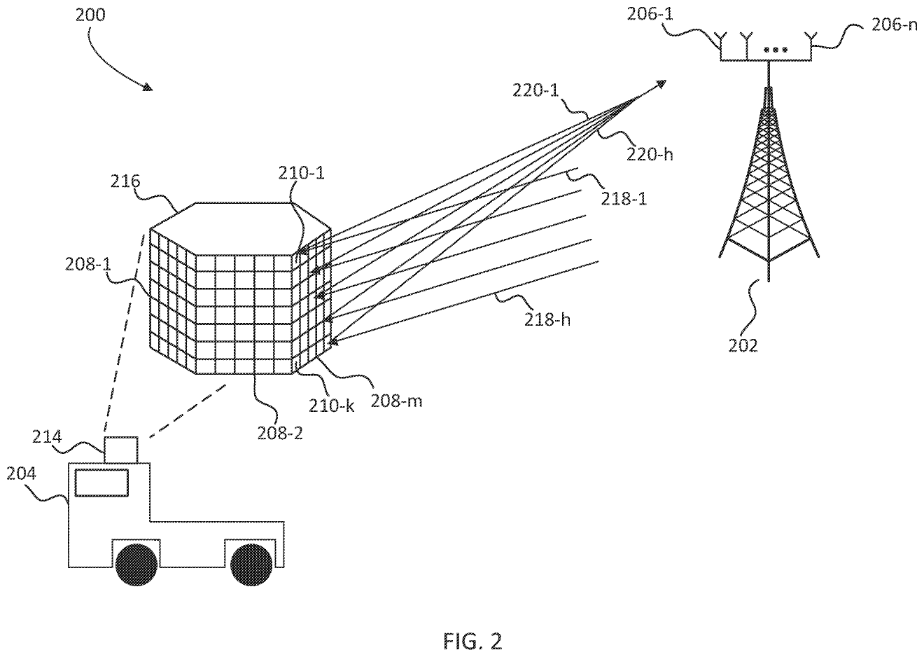

Moreover, in the existing FDD systems, acquiring the downlink channel estimates has a large signaling overhead and latency. The UE transmits a quantized version of the downlink channel measurements as feedback to the base station. The feedback signaling results in providing an outdated channel state information (CSI) and inaccuracy due to the quantization-errors. The channel reciprocity in TDD networks gives a better performance in terms of the signaling overhead and latency. The UE transmits a sounding signal which is measured at the BS receiver to obtain the CSI and then used for the downlink transmissions to the same UE. However, this technique still has a few drawbacks. First, it requires the UE to transmit a sounding signal even when the UE is not interested in the uplink data transmission. Second, the sounding channel transmission uses the precious uplink resources resulting in reduced uplink data capacity. The aforementioned issues may be overcome by IRS-aided channel estimation, as will be described below with reference to FIG. 2.

FIG. 2 illustrates an exemplary wireless communication network 200 for wireless communication and channel estimation, in accordance with some embodiments of the present disclosure. In some embodiments, the exemplary wireless communication network 200 comprises a BS 202 and a UE 204. In some embodiments, the BS 202 comprises a plurality of antennas 206-1 to 206-n as shown. The plurality of antennas 206-1 to 206-n may be arranged in an antenna array and be in communication with the UE 204 to form a multiple input and single output (MISO) system. In some embodiments, the plurality of antennas 206-1 to 206-n is configured to form a uniform linear antenna array. In some other embodiments, the plurality of antennas 206-1 to 206-n may form a planar antenna array or a frequency scanning antenna array. The frequency scanning antenna array may be referred to as a type of phased array antenna that changes the direction of its radiation pattern by varying the frequency of the input signal. Although FIG. 2 illustrates an embodiment of a MISO system, the present disclosure is not limited to MISO systems, and can be applied to other types of communication systems, such as multiple input multiple output (MIMO) systems, single input multiple output (SIMO) systems, and single input single output (SISO) systems having corresponding antenna configurations. In some embodiments, the UE 204 comprises an IRS that includes a plurality of antennas that can provide multiple outputs in a MIMO system. In some embodiments, the antennas in the plurality of antennas 206-1 to 206-n are evenly spaced on a straight line, wherein each pair of neighbored antennas has a fixed distance. In some other embodiments, the antennas in the plurality of antennas 206-1 to 206-n are arranged on a straight line, wherein different pairs of neighbored antennas have different distances.

In some embodiments, the UE 204 comprises an IRS 214 attached to the main body of the UE 204. In some other embodiments, the UE 204 is a vehicle (for example, self-driving car), and the IRS 214 may be installed on the roof of the UE 204. In yet some other embodiments, the IRS 214 is installed on mobile robots of the UE 204. In still some other embodiments, the UE 204 is a UAV and the IRS 214 is placed facing the ground. In still some other embodiments, the UE 204 is a handheld device, and the IRS 214 is installed on the UE 204. The UE 204 may be connected to the IRS 214 through a wire or a wireless communication channel while the UE 204 and the IRS 214 are located at different locations.

In some embodiments, the IRS 214 comprises one or more intelligent reflecting surfaces. A zoomed view 216 of the IRS 214 is shown in FIG. 2. In some embodiments, the zoomed view 216 of the IRS 214 comprises a plurality of intelligent reflecting surfaces 208-1 to 208-m placed on side surfaces of a polygonal cylinder shape as shown. Each of the intelligent reflecting surfaces 208-1 to 208-m may comprises a plurality of reconfigurable reflecting elements. For example, the intelligent reflecting surface 208-m may comprise a plurality of reconfigurable reflecting elements 210-1 to 210-k. In one embodiment, each of the plurality of reconfigurable reflecting elements 210-1 to 210-k comprises a respective metallic patch printed on a dielectric substrate, and each of the respective metallic patches can be configured to manipulate incident signals. In some other embodiments, a control circuit board installed in the IRS 214 can be configured to activate the plurality of reconfigurable reflecting elements 210-1 to 210-k.

In some embodiments, the plurality of antennas 206-1 to 206-n in the BS 202 may be in communication with the respective plurality of reconfigurable reflecting elements in each of the plurality of intelligent reflecting surfaces 208-1 to 208-m to form a MIMO system. For example, the plurality of antennas 206-1 to 206-n and the plurality of reconfigurable reflecting elements 210-1 to 210-k may form a first MIMO system for positioning estimation of the UE 204 and for channel estimation. In the first MIMO system, the BS 202 comprising the plurality of antennas 206-1 to 206-n may be configured to transmit a first plurality of signals 218-1 to 218-h to the plurality of reconfigurable reflecting elements 210-1 to 210-k, wherein each of the plurality of reconfigurable reflecting elements 210-1 to 210-k are configured to receive the first plurality of signals 218-1 to 218-h. In one embodiment, the first plurality of signals 218-1 to 218-h comprises K subcarriers (K≥1) orthogonal frequency-division multiplexing reference signals. Upon receiving the first plurality of signals 218-1 to 218-h, each of the plurality of reconfigurable reflecting elements 210-1 to 210-k may be configured to reflect the first plurality of signals 218-1 to 218-h to produce a respective one of a plurality reflected second signals 220-1 to 220-h. In some embodiments, for the first plurality of signals 218-1 to 218-h received at the IRS 214, a respective AoA at each of the plurality of reconfigurable reflecting elements 210-1 to 210-k is slightly different due to slight different locations of each of the plurality of reconfigurable reflecting elements 210-1 to 210-k. In such a case, the amplitude and/or phase shifts in each of the plurality of reconfigurable reflecting elements 210-1 to 210-k may be jointly adjusted such that each of the plurality of reconfigurable reflecting elements 210-1 to 210-k reflects the first plurality of signals 218-1 to 218-h at its respective AoA to form a beam that reaches the destination node with the maximum power. In some embodiments, each of the plurality of reconfigurable reflecting elements 210-1 to 210-k reflects the first plurality of signals 218-1 to 218-h to generate a respective one of a plurality of reflected second signals 220-1 to 220-h, such that the plurality of reflected second signals 220-1 to 220-h is focused towards the transmission node BS 202. In some embodiments, the plurality of reflected second signals 220-1 to 220-h forms a beam that reaches the destination node with the maximum power. In some embodiments, the power value of the beam formed by the plurality reflected second signals 220-1 to 220-h is larger than the corresponding power value in each of the plurality reflected second signals 220-1 to 220-h.

In one embodiment, the plurality of reconfigurable reflecting elements 210-1 to 210-k is adjusted by mechanical actuation via mechanical rotation to control the directions of the plurality reflected second signals 220-1 to 220-h. In another embodiment, the plurality of reconfigurable reflecting elements 210-1 to 210-k is adjusted by functional materials such as liquid crystal or graphene. In yet another embodiment, the plurality of reconfigurable reflecting elements 210-1 to 210-k is adjusted by electronic devices such as positive-intrinsic-negative (PIN) diodes, field-effect transistors (FETs), or micro-electromechanical system (MEMS) switches. The electronic devices used for controlling reflection of incident signals may provide fast response time, low reflection loss as well as relatively low energy consumption and hardware cost.

In some embodiments, the BS 202 may transmit a reference signal to the UE 204 coupled to the IRS 214. Upon receiving the transmitted reference signal, the IRS 214 may be configured to reflect the reference signal by focusing on a direction such that the reflected signal reaches the receiver of the BS 202 with sufficient strength. Then the BS 202 may perform channel estimation on the received reflected reference signal to compute a precoder for data transmission to the UE 202. For reliable channel estimation, the BS 202 may require all the following three parameter: of PMI, RI and CQI. In one embodiment, the PMI is computed based on estimated direction of the reflected reference signal. In another embodiment, the RI is computed based on the antenna ports configuration used by the UE 204. On the other hand, CQI is an index (example index values include 0, 1, 2, . . . , 15) used to represent the quality of transmission channel. In some embodiments, the CQI is computed by mapping a corresponding UE Signal-to-Noise Ratio (SNR) to the CQI. For example, higher SNR values can correspond to higher CQI values, indicating better channel quality. In some other embodiments, different modulation and coding schemes (MCSs) are associated with different CQI values. Therefore, the process of CQI estimation is intrinsically related to the process of downlink SNR estimation. In some embodiments, the BS 202 may estimate the CQI for the UE 204 coupled to the IRS 214 based on the measurements of the reflected reference signal received by the receiver of the BS 202. In some embodiments, for estimating the channel between the BS 202 and the UE 204, the BS 202 may be configured to transmit a reference signal to the UE 204 coupled to the IRS 214, and then estimate the reference signal received power (RSRP) and the intercell interference.

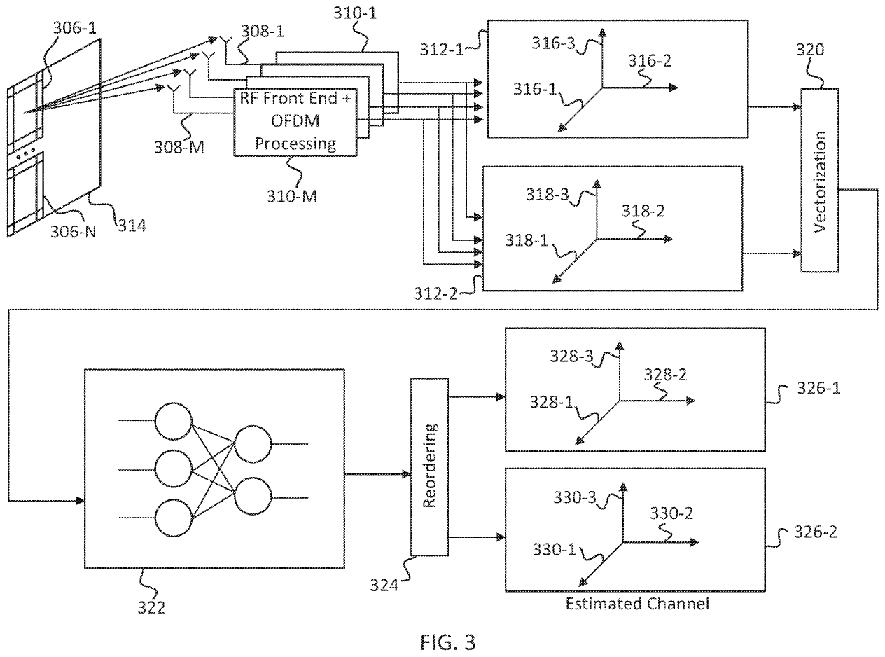

The IRS-aided channel estimation method described above can extend the UE's battery-life and improve uplink resources utilization. Furthermore, the IRS-aided channel estimation has much less signaling overhead and provides near real-time CSI. However, the IRS-aided channel estimation method can only be applied for downlink channel estimation, and it cannot be applied directly for FDD uplink transmission. The uplink channel estimates cannot be obtained directly from the downlink frequency channel measurements because the channel varies across the uplink and downlink frequency bands. To address the above problem of the downlink-uplink channel mismatch and improve the efficiency and accuracy of uplink channel estimation, a deep learning framework for uplink channel estimation will be described below with reference to FIG. 3.

The deep learning framework disclosed herein is implemented to map the IRS-reflected reference signal (RS) channel measurements taken on one frequency band to another frequency band to obtain the uplink CSI. Consequently, the disclosed deep learning framework is a general framework that can be used for IRS-aided channel estimation on other transmission types. The disclosed deep learning framework is well-suited to map the downlink channel on one frequency band to an uplink channel on another frequency band. As will be described below, an IRS-aided channel estimation deep learning framework is designed by customizing a general deep learning architecture, wherein the customization includes the IRS-aided RS samples as the input vector and an appropriate training dataset to generate the desired output.

FIG. 3 illustrates a Deep Neural Network (DNN) system at a BS used for IRS-aided BS-to-UE channel estimation, in accordance with some embodiments of the present disclosure. In some embodiments, a BS may be configured to transmit K subcarriers Orthogonal Frequency-Division Multiplexing (OFDM) RSs to a UE coupled to an IRS 314 on a downlink center frequency f_{DL}. In some embodiments, the K subcarriers are consecutive subcarriers. In some other embodiments, the K subcarriers are non-consecutive subcarriers. Although the MIMO-OFDM technique is described herein, the present disclosure is not limited to MIMO-OFDM and can be applied to any spatial-frequency-time based air interfaces. As such, the MIMO-OFDM transmission can be viewed as an embodiment for any spatial-frequency-time based air interface. In some embodiments, the IRS 314 comprises a total number of N antennas (N≥1) as shown by antennas 306-1 to 306-N in FIG. 3. Upon receiving the OFDM RSs from the BS, each of the N antennas 306-1 to 306-N in the IRS 314 may be configured to reflect the OFDM RSs to the transmitting BS. In some embodiments, the transmitting BS comprises a total number of M receiver antennas 308-1 to 308-M as shown, wherein the reflected OFDM RSs generated from each of the N antennas 306-1 to 306-N in the IRS 314 are received at each of the M receiver antennas 308-1 to 308-M at the transmitting BS. For example, the n-th antenna in the IRS 314 can be configured to reflect the respective OFDM RS to the m-th receiver antenna in the transmitting BS.

In some embodiments, to obtain channel samples from the n-th antenna in the IRS 314 to the m-th receiver antenna in the transmitting BS, the frequency-spaced RSs are transmitted from the BS in a set of N OFDM symbols where n={1, . . . , N} and m={1, . . . , M}, respectively. For example, each of the M antennas 308-1 to 308-M of the BS may transmit a total of N OFDM symbols to the UE coupled to the IRS 314, wherein each of the N OFDM symbols is associated with a respective one of the N antennas in the IRS 314. In some embodiments, the IRS 314 may be configured to activate only one of the N antennas during a respective one of N OFDM symbol durations in order to receive the RSs transmitted by the M antennas and reflect the received RSs. By activating only one of the N antennas at a time, interferences caused by multiple RS transmissions can be reduced. Upon receiving the reflected RSs, the transmitting BS may be configured to convert the received reflected RSs from radio frequency (RF) signals to digital signals, and then perform OFDM processing to obtain channel samples of signal transmission from the N IRS-UE antennas to the M BS antennas.

In some embodiments, the transmitting BS may comprise a plurality of OFDM processing blocks 310-1 to 310-M, wherein each of the M receiver antennas 308-1 to 308-M is connected to a respective one of the plurality of OFDM processing blocks 310-1 to 310-M. In some embodiments, each of the plurality of OFDM processing blocks 310-1 to 310-M may comprise a respective RF front end and respective OFDM processing functions, wherein the respective RF front end may comprise at least one low noise amplifier and at least one RF filter, and the OFDM processing functions may comprise signal processing functions such as Fast Fourier Transform (FFT). In some embodiments, the transmitting BS receives the N reflected OFDM symbols at N different time durations. For example, upon receiving the first reflected OFDM symbol, the BS may be configured to convert the received reflected OFDM RSs from RF signal format to digital signal format, and perform OFDM processing using the OFDM processing blocks 310-1 to 310-M to obtain the channel samples for signal transmission from the first IRS-UE antenna associated with the first reflected OFDM symbol to each of the M antennas in the transmitting BS. Then this process can be repeated for the next N−1 OFDM symbols to collect the channel samples from the remaining IRS-UE antennas. In one embodiment, a channel sample is obtained by measuring a real component signal value and a corresponding imaginary component signal value for a particular configuration, wherein the particular configuration comprises a particular antenna pair comprising a particular IRS-UE antenna and a particular BS antenna, as well as a particular subcarrier index. In some embodiments, the transmitting BS may transmit K (K>1) sets of N OFDM symbols to the IRS 314 at K different time durations, and the IRS 314 may be configured to reflect the K sets of N OFDM symbols back to the transmitting BS, wherein each of the K sets of N OFDM symbols comprises a respective set of N OFDM symbols. In such a case, the transmitting BS receives K copies for each of the reflected N OFDM symbols from the K sets of N OFDM symbols, wherein the K copies for each of the reflected N OFDM symbols are combined using a soft combining method to achieve greater signal to noise ratio. In some embodiments, the soft combining method is performed by the transmitting BS by keeping track of the probability or the confidence level of each bit in the OFDM symbol being a 0 or a 1. These probabilities may be then combined (e.g. by computing the average of the probabilities) across the K sets of N OFDM symbols to improve the likelihood of correctly decoding the received data.

In some embodiments, the received channel samples between all the N antennas in the IRS 314 and the M antennas in the transmitting BS may be organized in two 3-dimensional space-frequency arrays 312-1 and 312-2. In some embodiments, the 3-dimensional space-frequency array 312-1 comprises a first spatial dimension 316-1 with length corresponding to M×N antenna indices associated with the N antennas in the IRS 314 and the M antennas in the transmitting BS, a second spatial dimension 316-2 with length corresponding to the K subcarrier indices, and a third spatial dimension 316-3 corresponding to the real component value of each complex-valued channel sample. Similarly, the 3-dimensional space-frequency array 312-2 may comprise a first spatial dimension 318-1 with length corresponding to M×N antenna indices associated with the N antennas in the IRS 314 and the M antennas in the transmitting BS, a second spatial dimension 318-2 with length corresponding to the K subcarrier indices, and a third spatial dimension 318-3 corresponding to the imaginary component value of each complex-valued channel sample.

In some embodiments, when collecting the received channel samples between all the N antennas in the IRS 314 and the M antennas in the transmitting BS, the non-RS occupied subcarriers may be assigned zero values. As a result, the generated space-frequency arrays 312-1 and 312-2 may be sparse arrays. In some other embodiments, the non-RS occupied subcarriers may be filled with interpolated values obtained from RS occupied subcarriers. In such a case, the filled non-sparse space-frequency arrays may require a higher number of deep neural network hidden layers for later processing. In some embodiments, the BS may be configured to transmit multiple sets of N OFDM RS symbols to the UE coupled to the IRS 314 to collect more samples. The additional samples collected from the multiple sets of N OFDM RS symbols can be combined with the previous ones to obtain a stronger signal strength for the same samples. That is, the BS may transmit multiple sets of N OFDM RS symbols to the UE coupled to the IRS 314, and the IRS 314 may reflect each set of the multiple sets of N OFDM RS symbols to generated multiple sets of N reflected OFDM RS symbols back to the BS, wherein the multiple sets of N reflected OFDM RS symbols are combined into one combined signal for predicting the channel measurements at the uplink channel on the uplink frequency, wherein the signal strength of the combined signal is stronger than that of 1 set of N reflected OFDM RS symbols.

Once the received channel samples are collected, the complex-valued channel samples may be converted into a single 1-dimensional vector of length 2×K×M×N, as illustrated by the vectorization block 320 in FIG. 3. The purpose for converting the complex-valued channel samples to a single 1-dimensional vector is to transform the complex-valued channel samples to real values that will be used as inputs of the DNN. In some embodiments, the 3-dimensional space-frequency arrays 312-1 and 312-2 are flattened to become a single 1-dimensional vector of length 2×K×M×N. That is, each data element in the 3-dimensional space-frequency array 312-1 or 312-2 is converted to a corresponding data element in the 1-dimensional vector of length 2×K×M×N. This vectorization process is suitable given the type of the considered DNN. A fully connected network requires inputs to be in the form of vectors because a single forward pass usually corresponds to a sequence of matrix multiplication operations. In some embodiments, the centralization (i.e. deducting the average) and normalization (i.e. rescaling data values to [−1,1] interval) preprocessing operations may be operated on the converted 1-dimensional vector before the 1-dimensional vector is fed to the DNN.

In some embodiments, the converted 1-dimensional vector by the vectorization block 320 is fed to the inputs of a DNN 322, wherein the DNN 322 is a feedforward fully connected Multi-Layer Perceptron (MLP). Although an embodiment of a DNN is illustrated in FIG. 3, the present disclosure is not limited to DNN models, and any machine learning or neural network (NN) models can be used to implement the model provided by the DNN 322. For example, a recurrent neural network (RNN) model, a transformer neural network model, a convolutional neural network (CNN) model, a long short-term memory (LSTM) model, or a combination of these models can be used to implement the model provided by the DNN 322.

In some other embodiments, the DNN 332 comprises a plurality of layers, wherein each of the plurality of layers comprises a respective plurality of neurons, wherein the respective plurality of neurons is connected to outputs from all neurons of the previous layer. The particular structure of the DNN 332 may help the DNN model learn channel dependencies such that the model becomes capable of reconstructing the full channel estimates. In yet some other embodiments, the DNN comprises three non-linear transformations. The first transformation may take the input as a low-dimensional feature vector. The second transformation may comprise a series of the hidden-layers, taking the first transformation's output and passing it through a layer-by-layer series of higher-dimensional space such that the hidden layers learn an appropriate high-dimensional representation capturing the channel's interdependencies. The third transformation may take the high dimensional output of the second transformation and reconstruct a desired output feature vector which has the same low dimension as the input feature vector.

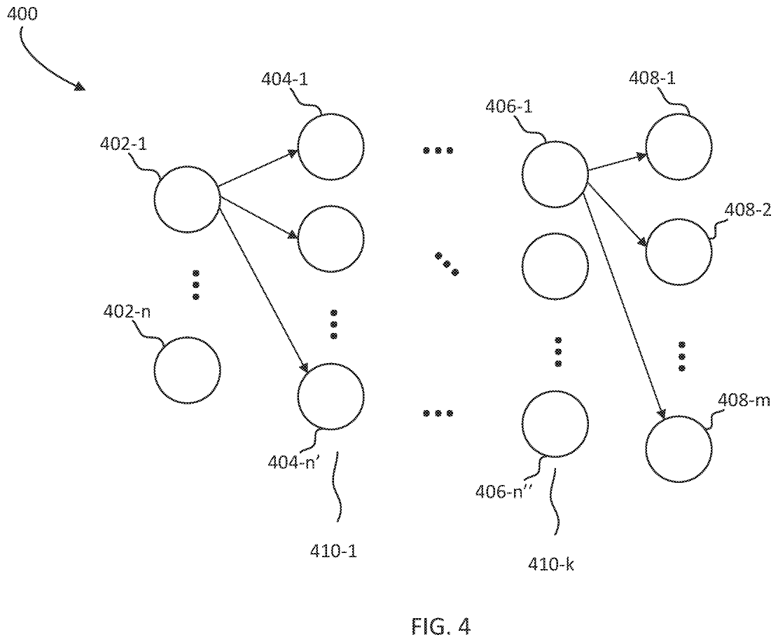

FIG. 4 illustrates a DNN model 400 used to implement the DNN 332 illustrated in FIG. 3, in accordance with some embodiments of the present disclosure. In some embodiments, the DNN model 300 comprises n inputs 402-1 to 402-n, k hidden layers 410-1 to 410-k as shown, and m outputs 408-1 to 408-m as shown. In some embodiments, the n inputs 402-1 to 402-n can be arranged in an input vector o=[o1, . . . , on] that corresponds to the converted 1-dimensional vector of length 2×K×M×N as described above with reference to FIG. 3, and the m outputs 408-1 to 408-m can be arranged in an output vector o(k+1)=[o1, . . . , om] corresponding to the transformed low dimension vector. In one embodiment, the DNN model 400 comprises a first hidden layer 410-1 comprising n′ inputs 404-1 to 404-n′, and the output vector of the first hidden layer 410-1 may be denoted by o(1) and computed using o(1)=s(o*W1), where s is a nonlinear activation function and W1 is a weight matrix connecting the input vector o to the first hidden layer. In the same way, the output vector o(k+1)=[o1, . . . , om] may be computed using o(k+1)=s( . . . (s(s(o*W1)*W2)) . . . *Wk+1), where Wg (g<k) is a weight matrix connecting the (g−1)-th hidden layer to the g-th hidden layer, and Wk is a weight matrix connecting the k-th hidden layer 410-k to the output vector o(k+1). In one embodiment, the k-th hidden layer 410-k comprises n″ inputs 406-1 to 406-n″.

In some embodiments, the DNN model 400 is trained using a plurality of samples, wherein each sample comprises an input vector and a corresponding output vector. In one embodiment, to find the optimal values of the weight matrices W1 to Wk+1 during the training of the DNN model 400, a back propagation algorithm is used by taking an error rate of a forward propagation and feeding this loss backward through the layers of the DNN model 400 to fine-tune the weights. In another embodiment, to find the optimal values of the weight matrices W1 to Wk+1 during the training of the ANN model 400, a weight perturbation technique can be used. The weight perturbation technique may be applied in an iterative manner for a plurality of iterations, wherein in each of the plurality of iterations, a weight variation of random sign is added to each of the elements in the weight matrices W1 to Wk+1 and a corresponding training error is observed. If the training error is increased in a given iteration, then the elements in the weight matrices W1 to Wk+1 will be changed to the opposite directions of the weight variations; if the training error is decreased in a given iteration, then the elements in the weight matrices W1 to Wk+1 will be changed to the same directions of the weight variations. This iterative training can be stopped if at least one of the following conditions is met: the training error becomes smaller than a predetermined error threshold value, a maximum number of iterations is reached, and the training error does not decrease for a predetermined number of iterations. In some embodiments, a dynamic weight perturbation technique can be applied to train the DNN model 400 by decreasing the amount of weight variations in each iteration, such that the DNN model 400 is fine-tuned towards the end of the training process. In one embodiment, the weight variation in the t-th iteration vₜ can be calculated as: vₜ=v₀/(t^{λ}), where v₀ is an initial weight variation amount, and λ is a user-defined parameter which controls the decrease rate of vₜ.

Referring back to FIG. 3, the output 1-D vector of the DNN 322 may be reordered back to two output 3-dimensional space-frequency arrays 326-1 and 326-2, as illustrated by the reordering processing block 324. In some embodiments, similar to the space-frequency arrays 312-1 and 312-2, the space-frequency array 326-1 may comprise a first spatial dimension 328-1 with length corresponding antenna indices, a second spatial dimension 328-2 with length corresponding to subcarrier indices, and a third spatial dimension 328-3 corresponding to the real component value of complex-valued channel samples. Similarly, the space-frequency array 326-2 may comprise a first spatial dimension 330-1 with length corresponding to antenna indices, a second spatial dimension 330-2 with length corresponding to subcarrier indices, and a third spatial dimension 330-3 corresponding to the imaginary component value of complex-valued channel samples. In some embodiments, the two space-frequency arrays 326-1 and 326-2 may be mapped to the input two space-frequency arrays 312-1 and 312-2 based on a mapping function φ, wherein the mapping function φ is represented by the DNN 322.

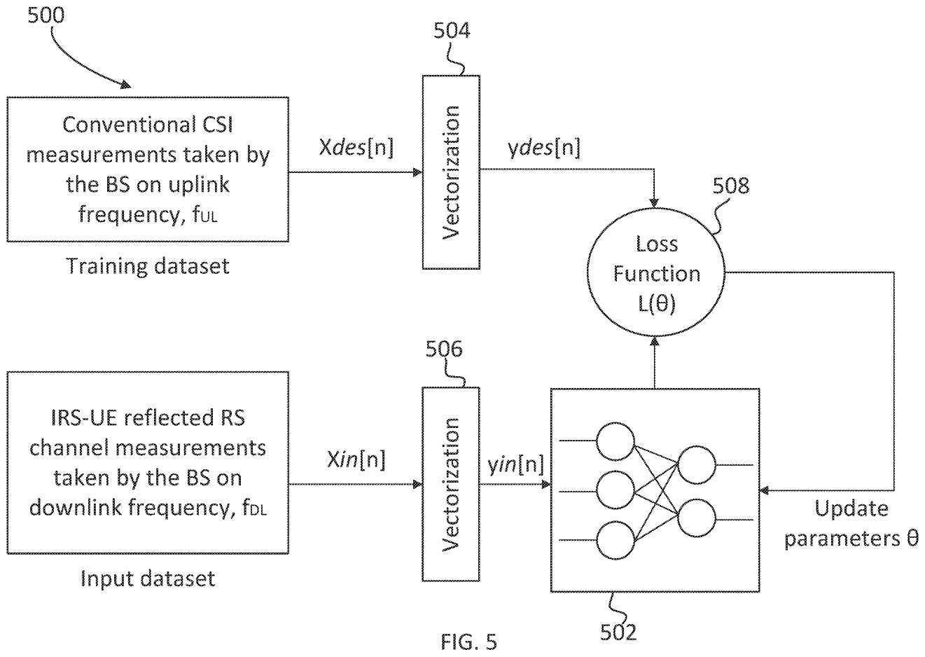

In some embodiments, the DNN 322 representing the mapping function φ may be trained using a supervised learning algorithm in order to reconstruct full channel arrays. The supervised learning may require two main components: a training dataset and a loss function. The training dataset may be defined as a set of samples collected from the environment or generated by synthetic data, each of which is a pair of input and its corresponding desired output. In some embodiments, the training set may be selected based on the type of channel estimates required for a specific transmission type, which will be described with further details below with reference to FIG. 5.

FIG. 5 illustrates a training structure 500 for channel estimation of uplink transmissions in FDD networks, in accordance with some embodiments of the present disclosure. The objective of the training structure 500 may be to train a DNN model 502 such that the DNN model 502 learns the IRS-UE reflected RS channel measurements Xᵢₙ∈C^{N×M×K} taken on the downlink frequency f_{DL}, and maps measurements Xᵢₙ to the channel measurements on uplink channel on frequency f_{UL}. In one embodiment, the downlink frequency f_{DL} is the same as the uplink frequency f_{UL}. In another embodiment, the downlink frequency f_{DL} is different from the uplink frequency fu. In some embodiments, the training dataset in training structure 500 comprises conventional channel measurements X_{des}∈C^{N×M×K} of the SRS transmitted from a UE to a BS's receiver on the uplink frequency f_{UL}. In some other embodiments, the DNN model 502 is trained using a plurality of training samples, wherein each of the plurality of training samples comprises a conventional channel measurement of the SRS transmitted from the UE to the BS on frequency f_{UL}, and a corresponding IRS-UE reflected RS channel measurement taken on the downlink frequency f_{DL}, wherein the IRS-UE reflected RS is generated by reflecting RS transmitted from the BS to the IRS coupled to the UE. The n-th sample measurement Xᵢₙ[n] may be paired with a corresponding X_{des}[n], then Xᵢₙ and X_{des} may go through a sequence of processing operations as illustrated by the vectorization processing blocks 504 and 506. The functions of the vectorization processing blocks 504 and 506 are similar to those in the vectorization block 320. In some embodiments, the centralization and normalization preprocessing operations may be performed on Xᵢₙ and X_{des} before Xᵢₙ and X_{des} are fed into the vectorization processing blocks 504 and 506. In some embodiments, the vectorization processing blocks 504 and 506 match the spatial dimensions of the vectors X_{des} and Xᵢₙ by generating a single 1-dimensional vector y_{des}∈ [symbol] ^{2NMK} and yᵢₙ∈ [symbol] ^{2NMK}, respectively. This implies that the indices [1, 2, . . . , 2×N×M×K] of the vectors y_{des}[n] and yᵢₙ[n] are one-to-one matched between a first link and a second link, wherein the first link is the link between the IRS-UE's i^{th} antenna and the BS's j^{th} receive antenna in the vectors X_{des} on the k^{th} subcarrier, and the second link is the link between the IRS-UE's i^{th} antenna and the BS's j^{th} receive antenna in the vectors Xᵢₙ on the k^{th} subcarrier. In some embodiments, the length of the vectors y_{des}[n] and yᵢₙ[n] are a product of 2, M, N and K, wherein 2, M, N and K represent the total number of real and imaginary components, the number of BS antennas, the number of IRS-UE antennas, and the number of OFDM subcarriers, respectively. In some embodiment, the training of the DNN model 502 is performed using small batches of inputs and their associated desired outputs.

In some embodiments, a loss function 508 may be used to train the DNN model 502 in the training structure 500. The loss function may be referred to as a measure of the model performance during the training. Examples of loss functions include Mean Squared Error (MSE), Normalized Mean Squared Error (NMSE), Mean Absolute Error (MAE), Huber loss, cross-entropy loss, or any other suitable loss functions. In one embodiment, the NMSE is used as the loss function, wherein the loss function is expressed as:

$$l = \frac{1}{2 MNK} {\sum }_{i = 1}^{MNK} \frac{{‖ {y}_{out} - {y}_{des} ‖}_{2}^{2}}{{‖ {y}_{des} ‖}_{2}^{2}} ,$$

where yₒᵤₜ, y_{des}∈ [symbol] ^{MNK} are vectorized actual single model output and its desired ideal response, respectively. In some embodiments, the training process comprises adjusting the model parameters θ of the DNN model 502 such that the loss function 508 is minimized. After the training is complete, the mapping function φ corresponding to the DNN model 502 may be represented by the learned optimal model parameters θ, which is defined as the weighted DNN's results in the best channel estimates approximation. In some embodiment, the trained DNN model 502 may be deployed in the DNN system shown in FIG. 3 and the IRS-aided field channel measurements may be used as the inputs to obtain the channel estimates as the outputs. The outputs of the DNN model 502 may be reordered into two 3-dimensional arrays to represent the complex values of the channel estimates as shown in FIG. 3.

In some embodiments, the training structure 500 may be reused to train the DNN model 502 for other transmission types by using a different training sets. The same procedure may be used to generate the input vector comprising the reflected RS measurements on the downlink channel at the BS. The learned parameters θ may be obtained by selecting a training set appropriate for the transmission type as listed below with reference to Table 1. The model mapping function φ may change according to the training set applied. For example, in the FDD uplink scenario, the mapping function's objective is to map the IRS reflected RS channel measurements on f_{DL}, to the UE's SRS transmission uplink channel measurements on frequency f_{UL} acquired at the BS receiver. In the FDD downlink scenario, the mapping function's objective may be to simply map the IRS reflected channel measurements to the downlink channel measurements acquired at the UE. Once the DNN model 502 is trained, it may be placed and deployed in the field to obtain the channel estimates of the considered channel. Table 1 also lists some additional pre-processing and post-processing operations needed for the input training set and the channel estimates output, respectively, for different considered transmission types.

TABLE 1
Training dataset and pre- and post-processing for different
transmission type.

| Transmission | Conventional | Training | Pre-Processing and |
|---|---|---|---|
| Type | Method | Dataset X_{des} | Post-Processing |
| FDD, | UE's | Downlink | Additional preprocessing |
| Downlink on | downlink | channel | operation Reciprocity |
| ƒ_{DL} | channel | measurements | is applied to Xᵢₙ |
| | measurements | on ƒ_{DL} at | ∈ [symbol] ^{M x N x} ^{K}, to obtain |
| | sent in | the UE | the output vector's |
| | feedback | | appropriate |
| | | | dimension |
| | | | of [symbol] ^{N x N x} ^{K}. Also, as |
| | | | part of post- |
| | | | processing, the gain |
| | | | coefficients of |
| | | | the output are |
| | | | rescaled based on |
| | | | the computed |
| | | | CQI. |
| FDD, | BS measures | Uplink channel | None. |
| Uplink | the SRS | measurements | |
| on ƒ_{UL} | transmissions | on ƒ_{UL} at | |
| | from the UE | the BS | |
| TDD, | BS measures | Downlink | Additional preprocessing |
| Downlink on | the SRS | channel | operation Reciprocity |
| ƒ_{TDD} | transmissions | measurements | is applied to Xᵢₙ |
| | from the UE | on ƒ_{TDD} | ∈ [symbol] ^{M x N x} ^{K}, to |
| | and applies | at the UE | obtain the output |
| | reciprocity | | vector's appropriate |
| | | | dimension of [symbol] ^{N x N x} ^{K}. |
| | | | Also, as part of post- |
| | | | processing, the gain |
| | | | coefficients of |
| | | | the output are |
| | | | rescaled based on |
| | | | the computed |
| | | | CQI. |
| TDD, | BS measures | Uplink Channel | None. |
| Uplink on | the SRS | measurements | |
| ƒ_{TDD} | transmissions | on ƒ_{TDD} | |
| | from the UE | at the BS | |

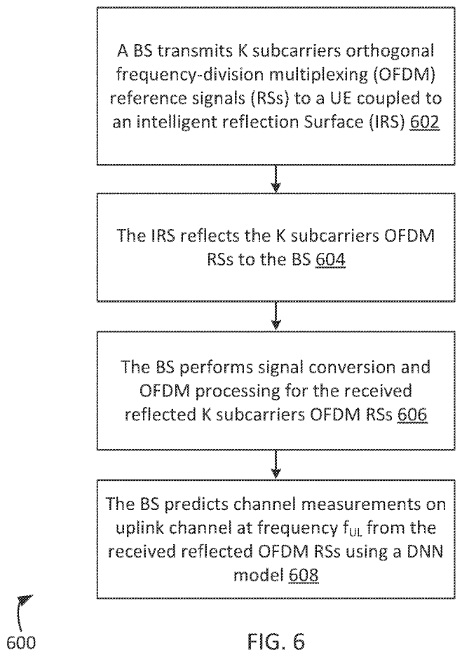

FIG. 6 illustrates an example method 600 for performing deep learning MIMO channel estimation for IRS installed UE, in accordance with some embodiments. The operations of method 600 presented below are intended to be illustrative. In some embodiments, method 600 may be accomplished with one or more additional operations not described and/or without one or more of the operations discussed. Additionally, the order in which the operations of method 600 are illustrated in FIG. 6 and described below is not intended to be limiting.

At step 602, a BS transmits K subcarriers (K≥1) OFDM RSs to a UE coupled to an IRS. In some embodiments, the IRS comprises a total number of N antennas (N≥1), and the BS comprises a total of M receiver antennas (N≥1). In some embodiments, to obtain channel samples from the n-th antenna in the IRS to the m-th receiver antenna in the transmitting BS, the frequency-spaced RSs are transmitted from the BS in a set of N OFDM symbols where n={1, . . . , N} and m={1, . . . , M}, respectively. For example, each of the M antennas of the BS may transmit a total of N OFDM symbols to the UE coupled to the IRS, wherein each of the N OFDM symbols is associated with a respective one of the N antennas in the IRS. In some embodiments, the IRS may be configured to activate only one of the N antennas during a respective one of N OFDM symbol durations in order to receive the RSs transmitted by the M antennas and reflect the received RSs. By activating only one of the N antennas at a time, interferences caused by multiple RS transmissions can be reduced.

At step 604, upon receiving the K subcarriers OFDM RSs from the BS, each of the N antennas in the IRS may be configured to reflect the OFDM RSs to the transmitting BS. In some embodiments, the reflected OFDM RSs generated from each of the N antennas in the IRS are received at each of the M receiver antennas at the transmitting BS. In some embodiments, the IRS may be configured to reflect the K subcarriers OFDM RSs by focusing on a direction such that the reflected K subcarriers OFDM RSs reach the receiver of the BS with sufficient strength.

At step 606, upon receiving the reflected RSs, the transmitting BS may be configured to convert the received reflected RSs from RF signals to digital signals, and then perform OFDM processing to obtain channel samples of signal transmission from the N IRS antennas to the M BS antennas. In some embodiments, the transmitting BS receives the N reflected OFDM symbols at N different time durations. Upon receiving the first reflected OFDM symbol, the BS may be configured to convert the received reflected OFDM RSs from RF signal format to digital signal format, and perform OFDM processing to obtain the channel samples, wherein the channel samples are taken from the signal transmission from the first IRS antenna associated with the first reflected OFDM symbol to each of the M antennas in the transmitting BS. Then this process can be repeated for the next N−1 OFDM symbols to collect the channel samples from the remaining IRS antennas. In some embodiments, a channel sample is obtained by measuring a real component signal value and a corresponding imaginary component signal value for a particular configuration, wherein the particular configuration comprises a particular antenna pair comprising a particular IRS antenna and a particular BS antenna, as well as a particular subcarrier index. In some embodiments, the received channel samples between the N antennas in the IRS and the M antennas in the transmitting BS may be organized in two 3-dimensional space-frequency arrays, wherein the two 3-dimensional space-frequency arrays comprise a first spatial dimension with length corresponding to M×N antenna indices, a second spatial dimension with length corresponding to the K subcarrier indices, and a third spatial dimension corresponding to the real or imaginary component value of each complex-valued channel sample. In some embodiments, the BS may be configured to transmit multiple sets of N OFDM RS symbols to the UE coupled to the IRS 314 to collect more samples. The additional samples collected from the multiple sets of N OFDM RS symbols can be combined with the previous ones to obtain a stronger signal strength for the same samples. In some embodiments, the complex-valued channel samples may be converted into a single 1-dimensional vector of length 2×K×M×N, which will be used as inputs of a DNN model.

At step 608, the BS may be configured to predict channel measurements on uplink channel at frequency f_{UL} based on the converted reflected RS sample measurements taken on downlink frequency f_{DL} at step 606. In some embodiments, BS predicts channel measurements on uplink channel at frequency f_{UL} from the converted reflected RS sample measurements on downlink channel frequency f_{DL} using a DNN model, wherein the DNN model is trained using training samples, wherein the training samples comprise conventional channel measurements of the SRS transmitted from the UE to the BS on the uplink channel at frequency f_{UL}, as well as samples of IRS-UE reflected RS channel measurements taken on the downlink frequency f_{DL}. In some embodiments, the DNN model output is a 1-dimensional vector, and the 1-dimensional vector DNN output may be reordered to two output 3-dimensional space-frequency arrays.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and functions described herein can be implemented within or performed by one or more circuits or circuitry. As used herein, the term “circuitry” refers to and includes any one or more of the following: discrete circuit components or devices coupled to each other to form circuit, logic circuitry, integrated circuits, application specific integrated circuits, state machines, general purpose processors, special purpose processors, digital signal processors (DSP), microprocessors, field programmable gate arrays (FPGA) or other programmable logic devices, or any combination thereof. Circuitry can further include antennas, reflectors, transmitters, receivers and/or transceivers to communicate with various components, devices or nodes within a communication network. As used herein, the term “processor” refers to a combination of structures including processing circuitry, a memory coupled to the processing circuitry, and executable code stored in the memory that when executed by the processing circuitry perform the functions or operations instructed by the executable code.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such non-transitory computer-readable media can include RAM, ROM, EEPROM, CD-ROM or other optical disk storage, magnetic disk storage or other magnetic storage devices, or any other non-transitory medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method comprising:
receiving, at a wireless communication device, a first signal at a first frequency from a wireless communication node; and
reflecting, at the wireless communication device, the first signal to generate a reflected first signal back to the wireless communication node, wherein the first signal is reflected using an intelligent reflecting surface (IRS) coupled to the wireless communication device, wherein the reflected first signal is used for a channel estimation of a second frequency, and wherein the first frequency and the second frequency are different.

2. The method of claim 1, wherein the channel estimation of the second frequency is performed by estimating channel measurements on an uplink channel at the second frequency, wherein the channel measurements on the uplink channel at the second frequency are estimated using a neural network (NN) model, wherein the NN model is trained using a plurality of training samples, wherein each of the plurality of training samples comprises:
an IRS-reflected reference signal (RS) measurement at the first frequency; and
an associated sounding reference signal (SRS) measurement transmitted from the wireless communication device to the wireless communication node at the second frequency.

3. The method of claim 1, wherein the first signal comprises a plurality of orthogonal frequency-division multiplexing (OFDM) symbols, wherein each of the plurality of OFDM symbols is transmitted from the wireless communication node to a respective one of a plurality of antennas in the IRS during a respective one of a plurality of symbol durations, wherein:
during the respective one of the plurality of symbol durations, the respective one of the plurality of antennas is activated while all other antennas in the plurality of antennas are deactivated.

4. The method of claim 2, wherein the channel measurements on the uplink channel at the second frequency are estimated using inputs of the NN, wherein the inputs of the NN are obtained by:
converting the reflected first signal from a radio frequency (RF) format to a digital format; and
converting the reflected first signal with the digital format from a complex number to a one-dimensional vector.

5. The method of claim 1, further comprising:
receiving, at the wireless communication device, a plurality of second signals at the first frequency from the wireless communication node; and
reflecting, at the wireless communication device, each of the plurality of second signals to generate a respective one of a plurality of reflected second signals back to the wireless communication node using the IRS coupled to the wireless communication device, wherein the reflected first signal and the plurality of reflected second signals are used for the channel estimation of the second frequency using the NN.

6. The method of claim 5, wherein the reflected first signal and the plurality of reflected second signals are combined into a combined signal for the channel estimation of the second frequency, wherein a first signal strength of the combined signal is stronger than a second signal strength of the reflected first signal.

7. The method of claim 2, wherein the NN is a feedforward fully connected multi-layer perceptron (MLP).

8. A wireless communication device comprising:
a transceiver configured to receive a first signal at a first frequency from a wireless communication node; and
an Intelligent Reflecting Surface (IRS) configured to reflect the first signal to generate a reflected first signal back to the wireless communication node, wherein the reflected first signal is used for a channel estimation of a second frequency, and wherein the first frequency and the second frequency are different.

9. A non-transitory computer readable medium storing computer-executable instructions which when executed cause the wireless communication device to perform the method of claim 1.

10. Circuitry configured to cause the wireless communication device to perform the method of claim 1.

11. A method comprising:
transmitting, at a wireless communication node, a first signal at a first frequency to a wireless communication device; and
receiving, at the wireless communication node, a reflected first signal, wherein the reflected first signal is generated by an intelligent reflecting surface (IRS) coupled to the wireless communication device by reflecting the first signal, wherein the reflected first signal is used for a channel estimation of a second frequency, and wherein the first frequency and the second frequency are different.

12. The method of claim 11, wherein the channel estimation of the second frequency is performed by estimating channel measurements on an uplink channel at the second frequency, wherein the channel measurements on the uplink channel at the second frequency are estimated using a neural network (NN) model, wherein the NN model is trained using a plurality of training samples, wherein each of the plurality of training samples comprises:
an IRS-reflected reference signal (RS) measurement at the first frequency; and
an associated sounding reference signal (SRS) measurement transmitted from the wireless communication device to the wireless communication node at the second frequency.

13. The method of claim 11, wherein:
the first signal comprises a first plurality of sets of orthogonal frequency-division multiplexing (OFDM) symbols, wherein each of the first plurality of sets of OFDM symbols comprises a respective plurality of OFDM symbols; and
the reflected first signal comprises a second plurality of sets of reflected OFDM symbols, wherein each of the second plurality of sets of reflected OFDM symbols comprises a respective plurality of reflected OFDM symbols, wherein the second plurality of sets of reflected OFDM symbols is combined using a soft combining method.

14. The method of claim 12, wherein the channel measurements on the uplink channel at the second frequency are estimated using inputs of the NN, wherein the inputs of the NN are obtained by:
converting the reflected first signal from a radio frequency (RF) format to a digital format; and
converting the reflected first signal with the digital format from a complex number to a one-dimensional vector.

15. The method of claim 11, further comprising:
transmitting, at the wireless communication node, a plurality of second signals at the first frequency to the wireless communication device; and
receiving, at the wireless communication node, a plurality of reflected second signals, wherein the plurality of reflected second signals is generated by the IRS by reflecting the plurality of second signals, wherein the reflected first signal and the plurality of reflected second signals are used for the channel estimation of the second frequency using the NN.

16. The method of claim 15, wherein the reflected first signal and the plurality of reflected second signals are combined into a combined signal for the channel estimation of the second frequency, wherein a first signal strength of the combined signal is stronger than a second signal strength of the reflected first signal.

17. (canceled)

18. A non-transitory computer readable medium storing computer-executable instructions which when executed cause the wireless communication node to perform the method of claim 11.

19. Circuitry configured to cause the wireless communication node to perform the method of claim 11.

20. (canceled)
